(19) United States
(12) Patent Application Publication
(10) Pub. No.: US 2025/0261016 A1
(43) Pub. Date: Aug. 14, 2025

(54) MEASUREMENT GAP DEACTIVATION

(71) Applicant: QUALCOMM Incorporated, San Diego, CA (US)

(72) Inventors: Changhwan PARK, San Diego, CA (US); Carlos CABRERA MERCADER, Cardiff, CA (US); Chu-Hsiang HUANG, San Diego, CA (US); Prashant Sharma, San Marcos, CA (US)

(21) Appl. No.: 18/437,993

(22) Filed: Feb. 9, 2024

(51) Int. Cl. H04W 24/10; H04B 7/06; H04W 56/00

(52) U.S. Cl. CPC H04W 24/10; H04B 7/0626; H04W 56/0015

(57) ABSTRACT

Various aspects of the present disclosure generally relate to wireless communication. Some aspects more specifically relate to measurement gap deactivation. In some aspects, a network node may configure a user equipment (UE) with a plurality of conditions for deactivating a configured measurement gap. In some aspects, the plurality of conditions may include that the configured measurement gap is to be deactivated if configured measurements within the configured measurement gap are synchronization signal block (SSB) or channel state information reference signal (CSI-RS) intra-frequency measurements, the configured measurements are able to be performed without the configured measurement gap, a target measurement SSB is completely contained in an active downlink BWP of the UE, and a serving cell measurement object indicator is included in a corresponding BWP downlink dedicated information element. The UE may deactivate the measurement gap in accordance with the plurality of conditions being satisfied.

### FIELD OF THE DISCLOSURE

Aspects of the present disclosure generally relate to wireless communication and specifically relate to techniques, apparatuses, and methods associated with measurement gap deactivation.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

A measurement gap is a period that enables a user equipment (UE) or other device to measure signals received from a serving cell and one or more other cells. During the measurement gap, the UE may suspend communications with the serving cell and may measure a signal strength and signal quality, among other examples, of the signals received from the serving cell and the one or more other cells. The UE may identify whether to switch to another cell of the one or more other cells based at least in part on measurements performed within the measurement gap. A measurement gap may be activated or deactivated by the UE in accordance with one or more measurements that are to be performed within the measurement gap. The UE may activate the measurement gap, for example, in order to receive synchronization signal blocks (and/or other signals) from one or more other cells that are located nearby the UE. Alternatively, the UE may deactivate the measurement gap, for example, in order to receive synchronization signal blocks (and/or other signals) only from the current serving cell of the UE.

### SUMMARY

In some aspects, a method of wireless communication performed at a user equipment (UE) includes detecting that a plurality of conditions for deactivating a configured measurement gap are satisfied, wherein the plurality of conditions include that: configured measurements within the configured measurement gap are synchronization signal block (SSB) intra-frequency measurements or channel state information reference signal (CSI-RS) intra-frequency measurements, the configured measurements are able to be performed without the configured measurement gap, a target measurement SSB is completely contained in an active downlink bandwidth-part (BWP) of the UE, and a serving cell measurement object indicator is included in a corresponding BWP downlink dedicated information element; and deactivating the configured measurement gap in accordance with the plurality of conditions being satisfied.

In some aspects, a method of wireless communication performed at a network node includes transmitting an indication of a plurality of conditions for deactivating a configured measurement gap; and deactivating the configured measurement gap in accordance with the plurality of conditions being satisfied, wherein the plurality of are SSB intra-frequency measurements or CSI-RS intra-frequency measurements, the configured measurements are able to be performed without the configured measurement gap, a target measurement SSB is completely contained in an active downlink BWP of a UE, and a serving cell measurement object indicator is included in a corresponding BWP downlink dedicated information element.

In some aspects, an apparatus for wireless communication at a UE includes one or more memories storing processor-executable code; and one or more processors coupled with the one or more memories, at least one processor of the one or more processors configured to cause the UE to: detect that a plurality of conditions for deactivating a configured measurement gap are satisfied, wherein the plurality of conditions include that: configured measurements within the configured measurement gap are SSB intra-frequency measurements or CSI-RS intra-frequency measurements, the configured measurements are able to be performed without the configured measurement gap, a target measurement SSB is completely contained in an active downlink BWP of the UE, and a serving cell measurement object indicator is included in a corresponding BWP downlink dedicated information element; and deactivate the configured measurement gap in accordance with the plurality of conditions being satisfied.

In some aspects, an apparatus for wireless communication at a network node includes one or more memories storing processor-executable code; and one or more processors coupled with the one or more memories, at least one processor of the one or more processors configured to cause the network node to: transmit an indication of a plurality of conditions for deactivating a configured measurement gap; and deactivate the configured measurement gap in accordance with the plurality of conditions being satisfied, wherein the plurality of conditions include that: configured measurements within the configured measurement gap are SSB intra-frequency measurements or CSI-RS intra-frequency measurements, the configured measurements are able to be performed without the configured measurement gap, a target measurement SSB is completely contained in an active downlink BWP of a UE, and a serving cell measurement object indicator is included in a corresponding BWP downlink dedicated information element.

In some aspects, a non-transitory computer-readable medium storing a set of instructions for wireless communication includes one or more instructions that, when executed by one or more processors of a UE, cause the UE to: detect that a plurality of conditions for deactivating a configured measurement gap are satisfied, wherein the plurality of conditions include that: configured measurements within the configured measurement gap are SSB intra-frequency measurements or CSI-RS intra-frequency measurements, the configured measurements are able to be performed without the configured measurement gap, a target measurement SSB is completely contained in an active downlink BWP of the UE, and a serving cell measurement object indicator is included in a corresponding BWP downlink dedicated information element; and deactivate the configured measurement gap in accordance with the plurality of conditions being satisfied.

In some aspects, a non-transitory computer-readable medium storing a set of instructions for wireless communication includes one or more instructions that, when executed by one or more processors of a network node, cause the network node to: transmit an indication of a plurality of conditions for deactivating a configured measurement gap; and deactivate the configured measurement gap in accordance with the plurality of conditions being satisfied, wherein the plurality of conditions include that: configured measurements within the configured measurement gap are SSB intra-frequency measurements or CSI-RS intra-frequency measurements, the configured measurements are able to be performed without the configured measurement gap, a target measurement SSB is completely contained in an active downlink BWP of a UE, and a serving cell measurement object indicator is included in a corresponding BWP downlink dedicated information element.

In some aspects, an apparatus for wireless communication includes means for detecting that a plurality of conditions for deactivating a configured measurement gap are satisfied, wherein the plurality of conditions include that: configured measurements within the configured measurement gap are SSB intra-frequency measurements or CSI-RS intra-frequency measurements, the configured measurements are able to be performed without the configured measurement gap, a target measurement SSB is completely contained in an active downlink BWP of the apparatus, and a serving cell measurement object indicator is included in a corresponding BWP downlink dedicated information element; and means for deactivating the configured measurement gap in accordance with the plurality of conditions being satisfied.

In some aspects, an apparatus for wireless communication includes means for transmitting an indication of a plurality of conditions for deactivating a configured measurement gap; and means for deactivating the configured measurement gap in accordance with the plurality of conditions being satisfied, wherein the plurality of conditions include that: configured measurements within the configured measurement gap are SSB intra-frequency measurements or CSI-RS intra-frequency measurements, the configured measurements are able to be performed without the configured measurement gap, a target measurement SSB is completely contained in an active downlink BWP of a UE, and a serving cell measurement object indicator is included in a corresponding BWP downlink dedicated information element.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example network node in communication with an example user equipment (UE) in a wireless network.

FIG. 3 is a diagram illustrating an example of measurement gaps.

FIG. 4 is a diagram illustrating an example of measurement gap deactivation.

FIG. 5 is a flowchart illustrating an example process performed, for example, at a UE or an apparatus of a UE that supports wireless communication.

FIG. 6 is a flowchart illustrating an example process performed, for example, at a network node or an apparatus of a network node that supports wireless communication.

FIG. 7 is a diagram of an example apparatus for wireless communication that supports measurement gap deactivation.

FIG. 8 is a diagram of an example apparatus for wireless communication that supports measurement gap deactivation.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A measurement gap (MG) is a period that enables a user equipment (UE) or other device to measure signals received from a serving cell and one or more other cells. During the measurement gap, the UE may suspend communications with the serving cell and may measure a signal strength and signal quality, among other examples, of the signals received from the serving cell and the one or more other cells. The UE may identify whether to switch to another cell of the one or more other cells based at least in part on measurements performed within the measurement gap. In some examples, a configured measurement gap may be activated in accordance with one or more measurements that are to be performed within the measurement gap. For example, the configured measurement gap may be activated in accordance with the UE being configured to measure a synchronization signal block (SSB), a channel state information (CSI) reference signal (RS) (CSI-RS), or a positioning reference signal (PRS), and/or in accordance with the UE being configured to perform an evolved universal terrestrial radio access (e-UTRA) inter-radio access technology (RAT) measurement, among other examples.

A measurement gap may be activated or deactivated by the UE. The UE may activate the measurement gap, for example, in order to receive SSBs (and/or other signals) from one or more other cells that are located nearby the UE. Alternatively, the UE may deactivate the measurement gap, for example, in order to receive SSBs (and/or other signals) only from the current serving cell of the UE. The UE may measure the SSBs using intra-frequency SSB measurements or inter-frequency SSB measurements. Intra-frequency SSB measurements are SSB measurements that are confined to a single frequency layer and may be used by the UE to compare different SSBs within the single frequency layer. Alternatively, inter-frequency SSB measurements are SSB measurements that span across multiple frequency layers and may be used by the UE to compare SSBs from the different frequency layers. An SSB may be a cell-defining SSB (CD-SSB) or a non-cell-defining (NCD-SSB). A CD-SSB may be used for cell identification and may enable the UE to identify and synchronize with a cell within the network. The CD-SSB may include a physical call identifier (PCI) that enables the UE to identify and differentiate between various cells in the network. Alternatively, an NCD-SSB may not carry information for cell identification or cell selection. Instead, the NCD-SSB may be used for other purposes, such as to provide additional signal strength information or to assist the UE with performing a beamforming operation.

In some examples, a network node may configure the measurement gap at the UE via radio resource control (RRC) signaling. However, the measurement gap may not be activated unconditionally at the time the measurement gap is configured. Instead, the configured measurement gap may be activated or deactivated using additional RRC signaling and/or in accordance with one or more rules. For a legacy measurement gap or a network-controlled small gap (NCSG), SSB intra-frequency measurements may be performed without a measurement gap if a CD-SSB is within a configured UE-specific channel bandwidth (CBW), if the UE indicates ‘no-gap’ via an intra-Freq-needForGap indicator, if the SSB is completely contained in the active bandwidth-part (BWP), or if the active downlink BWP is an initial BWP. For a UE supporting nr-NeedForGapNCSG-reporting-r17 and indicating a NeedForGapNCSG-InfoNR for intra-frequency measurements, SSB intra-frequency measurements may be performed without a measurement gap if the UE indicates ‘nogap-noncsg’ via NeedForGapNCSG-InfoNR, the SSB is not completely contained in the active BWP, and the active downlink BWP is not an initial BWP.

In some examples, the UE and the serving cell may be out-of-sync with regard to whether or not a measurement gap is activated. This may result in wasted network resources. For example, the network node may schedule a data transmission via a PDSCH or PUSCH within the measurement gap. However, the data transmission may not be received by the UE, for example, since the UE may be performing measurements within the measurement gap in accordance with the measurement gap being autonomously activated by the UE without informing the serving cell. Additionally or alternatively, if the measurement gap is autonomously deactivated by the UE without informing the serving cell, UE power consumption may increase, for example, since the UE may continue to attempt to decode the PDCCH within the measurement gap while the serving cell is not transmitting to the UE via the PDCCH.

In some examples, the UE may perform Layer 3 (L3) intra-frequency measurements without measurement gaps using an NCD-SSB, where the NCD-SSB is within the active downlink (DL) BWP. However, UE autonomous rules for activating and deactivating the configured measurement gap may not include rules for activating and deactivating the configured measurement gap in accordance with the L3 intra-frequency measurements performed without gaps using the NCD-SSB. This may result in the UE failing to properly activate or deactivate the configured measurement gap in accordance with one or more rules. Failing to properly activate the measurement gap may cause the UE not to perform measurements within the configured measurement gap. This may result in the UE to remaining connected to the serving cell even when the serving cell does not have the highest signal quality of all serving cells within an area of the UE. Additionally or alternatively, failing to properly deactivate the measurement gap may result in wasted network resources (for example, due to UE not receiving a PDCCH or PDSCH communication within the configured measurement gap).

Various aspects relate generally to wireless communications. Some aspects more specifically relate to measurement gap deactivation. In some aspects, a network node (such as a network node associated with a serving cell of a UE) may configure a measurement gap at a UE. For example, the network node may transmit radio resource control (RRC) signaling that configures the measurement gap at the UE. Additionally, the network node may configure the UE with a plurality of conditions (for example, rules) for deactivating the configured measurement gap. In some aspects, the plurality of conditions may include that the configured measurement gap is to be deactivated if configured measurements within the configured measurement gap are SSB or CSI-RS intra-frequency measurements, the configured measurements are able to be performed without the configured measurement gap, a target measurement SSB is completely contained in an active downlink BWP of the UE, and a serving cell measurement object indicator (servingCellMO) is included in a corresponding BWP downlink dedicated information element (BWP-DownlinkDedicated). Additionally, the one or more conditions may include that a CD-SSB is within a configured UE-specific CBW, the UE transmits a no-gap indicator (no-gap) via an intra-frequency need for gap information element (intraFreq-needForGap), the SSB is completely contained in the active downlink BWP, and the active downlink BWP is an initial BWP. In some aspects, the target measurement SSB may be an NCD-SSB that is included in the active downlink BWP of the UE, and the plurality of conditions may be based at least in part on a configuration of the NCD-SSB and the serving cell measurement object indicator. The UE may deactivate the configured measurement gap in accordance with the plurality of conditions being satisfied. For example, the UE may deactivate the configured measurement gap, without receiving signaling from the network node that indicates to deactivate the measurement gap, in accordance with the configured measurements within the configured measurement gap being SSB or CSI-RS intra-frequency measurements, the configured measurements being able to be performed without the configured measurement gap, the target measurement SSB being completely contained in the active downlink BWP of the UE, and the serving cell measurement object indicator being included in the corresponding BWP downlink dedicated information element.

Particular aspects of the subject matter described in this disclosure can be implemented to realize one or more of the following potential advantages. In some examples, by enabling a configured measurement gap to be deactivated in accordance with a plurality of conditions, the described techniques can be used to enable the UE to deactivate the configured measurement gap without additional signaling from the network node. In some examples, by enabling the configured measurement gap to be deactivated in accordance with the plurality of conditions, the described techniques can be used to enable the UE to autonomously deactivate the configured measurement gap in accordance with Layer 3 intra-frequency measurements performed using an NCD-SSB that is within an active downlink BWP of the UE. In some examples, by enabling the configured measurement gap to be deactivated in accordance with the plurality of conditions, the described techniques can be used to enable the UE to perform intra-frequency SSB measurements outside of the configured measurement gap. In some examples, by enabling the configured measurement gap to be deactivated in accordance with the plurality of conditions, the described techniques can be used to enable the UE to switch from a serving cell to one or more other cells in accordance with the plurality of conditions being satisfied. In some examples, by enabling the configured measurement gap to be deactivated in accordance with the plurality of conditions, the described techniques can be used to increase a data rate and throughput in the network, for example, by scheduling a PDSCH and/or PUSCH communication within the deactivated measurement gap duration. These example advantages, among others, are described in more detail below.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (cMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

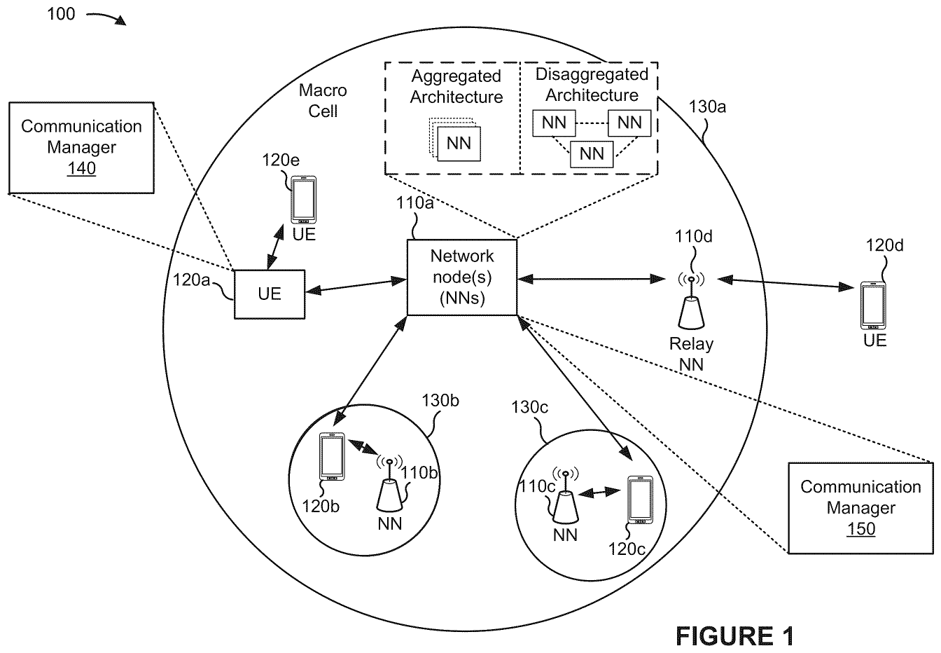

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHZ through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an uplink (UL) communication to a network node 110, which then transmits the data to the UE 120e in a DL communication.

In some aspects, the UE 120 may include a communication manager 140. As described in more detail elsewhere herein, the communication manager 140 may detect that a plurality of conditions for deactivating a configured measurement gap are satisfied, wherein the plurality of conditions include that: configured measurements within the configured measurement gap are SSB intra-frequency measurements or CSI-RS intra-frequency measurements, the configured measurements are able to be performed without the configured measurement gap, a target measurement SSB is completely contained in an active downlink BWP of the UE, and a serving cell measurement object indicator is included in a corresponding BWP downlink dedicated information element; and deactivate the configured measurement gap in accordance with the plurality of conditions being satisfied. Additionally or alternatively, the communication manager 140 may perform one or more other operations described herein.

In some aspects, the network node 110 may include a communication manager 150. As described in more detail elsewhere herein, the communication manager 150 may transmit an indication of a plurality of conditions for deactivating a configured measurement gap; and deactivate the configured measurement gap in accordance with the plurality of conditions being satisfied, wherein the plurality of conditions include that: configured measurements within the configured measurement gap are SSB intra-frequency measurements or CSI-RS intra-frequency measurements, the configured measurements are able to be performed without the configured measurement gap, a target measurement SSB is completely contained in an active downlink BWP of a UE, and a serving cell measurement object indicator is included in a corresponding BWP downlink dedicated information element. Additionally or alternatively, the communication manager 150 may perform one or more other operations described herein.

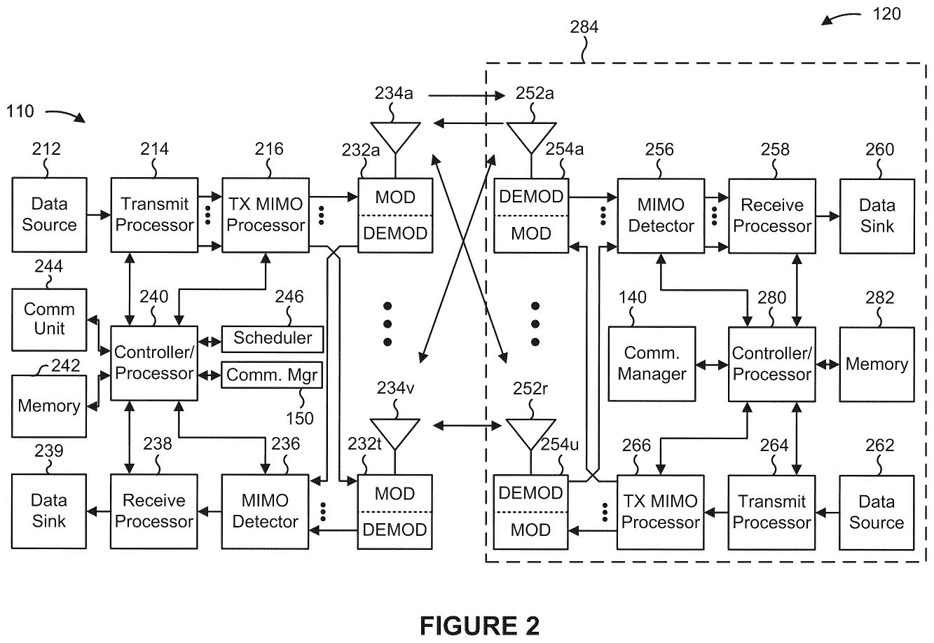

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor” or “a/the controller/processor,” among other examples (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a CSI-RS) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use downlink control information (DCI) to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information May include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include an uplink control information (UCI) communication, a medium access control (MAC) control element (MAC-CE) communication, an RRC communication, or another type of uplink communication. Uplink signals may be transmitted on a physical uplink shared channel (PUSCH), a physical uplink control channel (PUCCH), and/or another type of uplink channel. An uplink signal may carry one or more transport blocks (TBs) of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal.

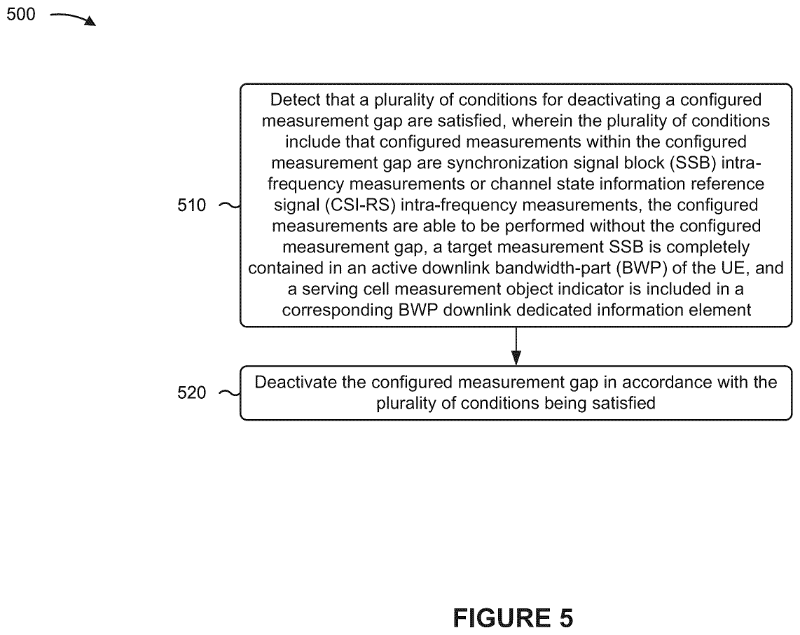

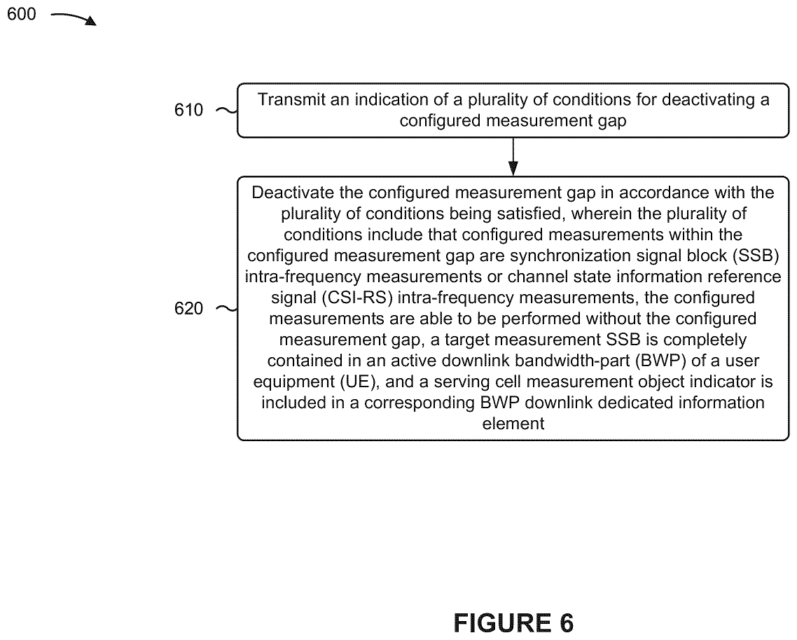

The network node 110, the controller/processor 240 of the network node 110, the UE 120, the controller/processor 280 of the UE 120, a CU, a DU, an RU, or any other component(s) of FIG. 1 or 2 may implement one or more techniques or perform one or more operations associated with measurement gap deactivation, as described in more detail elsewhere herein. For example, the controller/processor 240 of the network node 110, the controller/processor 280 of the UE 120, any other component(s) of FIG. 2, the CU, the DU, or the RU may perform or direct operations of, for example, process 500 of FIG. 5, process 600 of FIG. 6, or other processes as described herein (alone or in conjunction with one or more other processors). The memory 242 may store data and program codes for the network node 110, the network node 110, the CU, the DU, or the RU. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU, the DU, or the RU, may cause the one or more processors to perform process 500 of FIG. 5, process 600 of FIG. 6, or other processes as described herein. In some examples, executing instructions may include running the instructions, converting the instructions, compiling the instructions, and/or interpreting the instructions, among other examples.

In some aspects, the UE 120 includes means for detecting that a plurality of conditions for deactivating a configured measurement gap are satisfied, wherein the plurality of conditions include that: configured measurements within the configured measurement gap are SSB intra-frequency measurements or CSI-RS intra-frequency measurements, the configured measurements are able to be performed without the configured measurement gap, a target measurement SSB is completely contained in an active downlink BWP of the UE, and a serving cell measurement object indicator is included in a corresponding BWP downlink dedicated information element; and/or means for deactivating the configured measurement gap in accordance with the plurality of conditions being satisfied. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an indication of a plurality of conditions for deactivating a configured measurement gap; and/or means for deactivating the configured measurement gap in accordance with the plurality of conditions being satisfied, wherein the plurality of conditions include that: configured measurements within the configured measurement gap are SSB intra-frequency measurements or CSI-RS intra-frequency measurements, the configured measurements are able to be performed without the configured measurement gap, a target measurement SSB is completely contained in an active downlink BWP of a UE, and a serving cell measurement object indicator is included in a corresponding BWP downlink dedicated information element. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

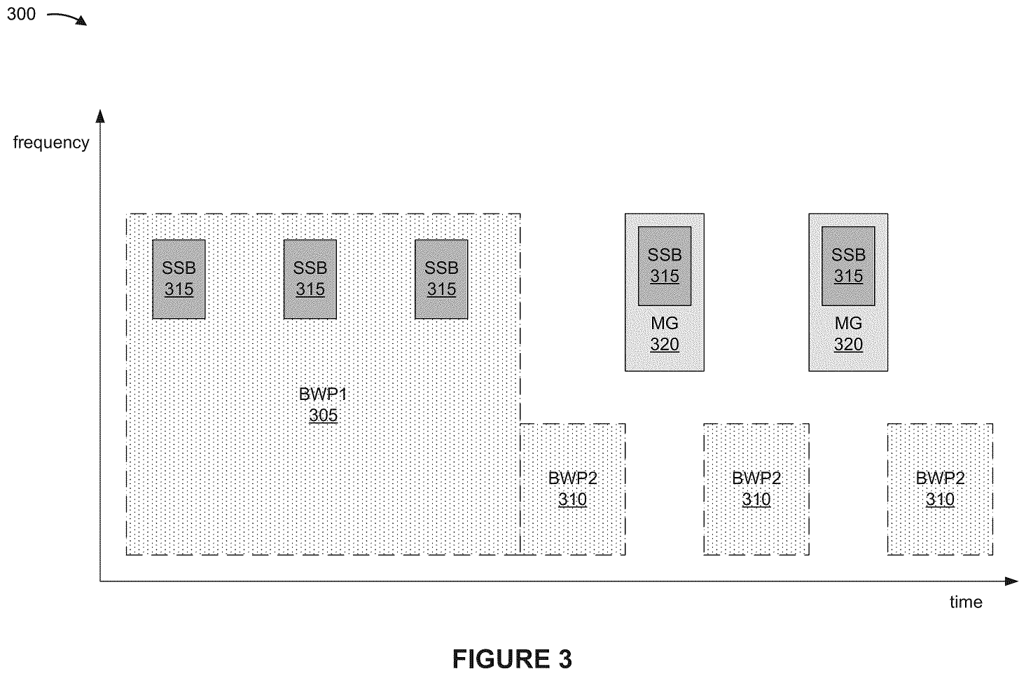

FIG. 3 is a diagram illustrating an example 300 of measurement gaps. The UE 120 may communicate using BWP1 305 and BWP2 310. A BWP is a contiguous set of subcarrier within an overall carrier bandwidth that may improve efficient use of the spectrum in accordance with UE requirements and network capabilities. The UE may be configured to measure SSB 315 within BWP1 305. However, the UE may not be configured to measure SSB 315 during MG 320.

In some examples, the MG may be configured (for example, pre-configured) by a network node via RRC signaling. However, the MG may not be activated unconditionally at the time the MG is configured. Instead, the configured MG may be activated or deactivated using RRC signaling or one or more autonomous rules. In some examples, there may be separate UE capabilities for each activation and deactivation mechanism. A configured MG may be per-UE or per-frequency. In some examples, a configured MG may only be supported in New Radio (NR) standalone (SA) mode (for single carrier or carrier aggregation (CA)).

A configured MG may be deactivated only if the configured measurements are either SSB measurements or CSI-RS intra-frequency measurements and if the measurements can be performed without the MG. One or more events may affect the activation or deactivation status of a configured MG. The one or more events may include an addition or removal of any measurement objects, a DCI-based, timer-based, or RRC-based active downlink (DL) BWP switch, an activation or deactivation of a secondary cell (SCell), or an activation, release, or change of the SCell.

Example conditions for SSB intra-frequency measurements without MG are described in Technical Specification (TS) 38.133 Section 9.2.1 of the 3GPP Specifications. For a legacy measurement gap or an NCSG, SSB intra-frequency measurements may be performed without an MG if a CD-SSB is within a configured UE-specific CBW, if the UE indicates ‘no-gap’ via an intra-Freq-needForGap indicator, if the SSB is completely contained in the active BWP, or if the active downlink BWP is an initial BWP. For a UE supporting nr-NeedForGapNCSG-reporting-r17 and indicating NeedForGapNCSG-InfoNR for intra-frequency measurements, SSB intra-frequency measurements may be performed without an MG if the UE indicates ‘nogap-noncsg’ via NeedForGapNCSG-InfoNR, the SSB is not completely contained in the active BWP, and the active downlink BWP is not an initial BWP.

Example conditions for SSB inter-frequency measurements without MG are described in TS 38.133 Section 9.3.1 of the 3GPP Specifications. For a legacy measurement gap or an NCSG, SSB inter-frequency measurements may be performed without an MG if the UE supports interFrequencyMeas-Nogap-r16 and the SSB is completely contained in the active BWP. For a UE supporting nr-NeedForGapNCSG-reporting-r17 and indicating NeedForGapNCSG-InfoNR for inter-frequency measurement, SSB inter-frequency measurements may be performed without an MG if the UE indicates ‘nogap-noncsg’ via NeedForGapNCSG-InfoNR and the SSB is not completely contained in the active BWP.

In some examples, if the UE does not support autonomous rules, the network may need to provide an activation or deactivation status indication for the gap for each BWP of each DL component carrier (CC) (such as each primary component carrier (PCC)) (when active) and for each secondary component carrier (SCC) when the corresponding SCC is deactivation. Example Table 1 shows gap statuses for various combinations of PCC indicators and SCC1 indicators. As shown in example Table 1, the gap status may be a logical XOR of a plurality of indicator.

Example Table 1

| PCC Indicator | SCC1 Indicators | | | |
|---|---|---|---|---|
| Per-BWP (for | Per-BWP (for | When | SCC1 | Gap |
| active BWP) | active BWP) | Inactive | Status | Status |
| 0 (=OFF) | N/A | 0 | inactive | OFF |
| 0 | N/A | 1 | inactive | ON |
| 1 (=ON) | N/A | 0 | inactive | ON |
| 1 | N/A | 1 | inactive | ON |
| 0 | 0 | 0/1 | active | OFF |
| 0 | 1 | 0/1 | active | ON |
| 1 | 0 | 0/1 | active | ON |
| 1 | 1 | 0/1 | active | ON |

In some examples, the activation and deactivation mechanism to be used may not be (explicitly) signaled. Instead, the activation and deactivation mechanism may be inferred from a presence of the deactivatedMeasGapList-r17 information element. The per-BWP gap status may be signaled by including deactivatedMeasGapList-r17 in a BWP-DownlinkDedicated indicator. The per-BWP gap status indicator may be OFF if the gap identifier (ID) is listed in deactivatedMeasGapList-r17. Additionally or alternatively, the behavior may be undefined for an initial DL BWP without a dedicated RRC configuration. In some examples, a per-SCC gap status may be signaled by including deactivatedMeasGapList-r17 in an SCellConfig indicator. For a UE that supports both autonomous rules and RRC-based mechanisms, there may be ambiguity when no deactivatedMeasGapList-r17 information elements are configured. Additional details are provided in example Table 2. Example Table 2 shows measurement gap activation and deactivations characteristics for various feature groups.

Example Table 2

| Features | Pre-Configured Gap | Pre-Configured Gap |
|---|---|---|
| Index | 19-3-1 | 19-3-2 |
| Feature Group | Pre-configured | Pre-configured |
| | measurement gap with | measurement gap with UE |
| | network-controlled | autonomous activation and |
| | activation and deactivation | deactivation mechanism |
| | mechanism | |
| Components | Capability of supporting | Capability of supporting |
| | pre-configured | pre-configured |
| | measurement gap with | measurement gap with UE |
| | network-controlled | autonomous mechanism for |
| | mechanism for activation | activation and deactivation |
| | and deactivation | |
| Consequences if the | UE does not support pre- | UE does not support pre- |
| feature is not supported | configured measurement | configured measurement |
| by the UE | gap with network- | gap with UE autonomous |
| | controlled mechanism | mechanism |
| Need for the network | Yes | Yes |
| node to be informed if the | | |
| feature is supported | | |
| Mandatory or Optional | Optional with capability | Optional with capability |
| | signaling | signaling |

Example Table 3 shows an example option (Option B-1-1) for BWP operation without restriction in NR. In this example, radio link management (RLM), beam management (BM), beam failure detection (BFD), and gapless L3 intra-frequency measurements may be supported based at least in part on a CD-SSB outside of the active BWP without interruptions.

Example Table 3

| | Prerequisite | | |
|---|---|---|---|
| | Feature | | Mandatory/ |
| Components | Groups | Note(s) | Optional |
| 1. UE performs | None | Note: The CD-SSB is | Optional with |
| RLM/BM/BFD | | still within the bandwidth | capability |
| measurements based at least | | of the carrier configured | signaling |
| in part on CD-SSB without | | by SCS-SpecificCarrier | |
| interruptions, where the | | of downlinkChannelBW- | |
| CD-SSB is outside active | | PerSCS-List in | |
| DL BWP but is within the | | ServingCellConfig. | |
| bandwidth of the | | Note: If the UE is | |
| corresponding carrier(s) to | | configured with more | |
| be measured. | | than one UE-specific DL | |
| 2. Bandwidth of UE- | | BWP configurations, the | |
| specific RRC configured | | CD-SSB is within the | |
| BWP may not include | | bandwidth of at least one | |
| bandwidth of control | | of the UE-specific DL | |
| resource set (CORESET) | | BWP configurations. | |
| CORESET#0 (if | | Note: UE may not | |
| CORESET#0 is present) | | indicate support of both | |
| and CD-SSB for | | B-1-1 and B-1-2 for the | |
| PCell/PSCell (if configured) | | same band in the same | |
| and bandwidth of the UE- | | reported band | |
| specific RRC configured | | combination. | |
| BWP may not include CD- | | Note: If a UE | |
| SSB for SCell. | | additionally indicates | |
| 3. CD-SSB outside active | | support of NeedForGap | |
| DL BWP but within the | | or NeedForGapNCSG | |
| bandwidth of the | | and/or | |
| corresponding carrier(s) to | | NeedForInterruption, the | |
| be measured can be used as | | UE may report no gap | |
| the quasi co-location (QCL) | | and no interruption/no | |
| source for other reference | | NCSG for intra- | |
| signal. | | frequency measurement. | |
| 4. UE performs L3 intra- | | This may not be | |
| frequency measurements | | applicable to reduced | |
| without gaps based at least | | capabilities (RedCap) or | |
| in part on CD-SSB, where | | enhanced RedCap | |
| the CD-SSB is outside of | | (eRedCap) UEs. | |
| the active DL BWP but is | | | |
| within the bandwidth of the | | | |
| corresponding carrier(s) to | | | |
| be measured. | | | |

Example Table 4 shows an example option (Option B-1-2) for BWP operation without restriction in NR. In this example, RLM, BM, and BFD may be supported based at least in part on a CD-SSB outside of the active BWP with interruptions.

Example Table 4

| | Prerequisite | | |
|---|---|---|---|
| | Feature | | Mandatory/ |
| Components | Groups | Note(s) | Optional |
| 1. UE performs | None | Note: The CD-SSB is | Optional with |
| RLM/BM/BFD | | still within the bandwidth | capability |
| measurements based on | | of the carrier configured | signaling |
| CD-SSB without | | by SCS-SpecificCarrier | |
| interruptions, where the | | of downlinkChannelBW- | |
| CD-SSB is outside active | | PerSCS-List in | |
| DL BWP but is within the | | ServingCellConfig. | |
| bandwidth of the | | Note: If a UE is | |
| corresponding carrier(s) to | | configured with more | |
| be measured. | | than one UE-specific DL | |
| 2. Bandwidth of UE- | | BWP configurations, the | |
| specific RRC configured | | CD-SSB is within the | |
| BWP may not include | | bandwidth of at least one | |
| bandwidth of the | | of the UE-specific DL | |
| CORESET#0 (if | | BWP configurations. | |
| CORESET#0 is present) | | Note: UE may not | |
| and CD-SSB for | | indicate support of both | |
| PCell/PSCell (if configured) | | B-1-1 and B-1-2 for the | |
| and bandwidth of the UE- | | same band in the same | |
| specific RRC configured | | reported band | |
| BWP may not include CD- | | combination. | |
| SSB for SCell | | Note: If a UE | |
| 3. CD-SSB outside active | | additionally indicates | |
| DL BWP but within the | | support of NeedForGap | |
| bandwidth of the | | or NeedForGapNCSG | |
| corresponding carrier(s) to | | and/or | |
| be measured can be used as | | NeedForInterruption, the | |
| the QCL source for other | | UE may report no gap | |
| reference signal. | | and no interruption/no | |
| 4. UE performs L3 intra- | | NCSG for intra- | |
| frequency measurements | | frequency measurement. | |
| without gaps based on CD- | | This may not be | |
| SSB, where the CD-SSB is | | applicable to RedCap or | |
| outside the active DL BWP | | eRedCap UEs. | |
| but is within the bandwidth | | | |
| of the corresponding | | | |
| carrier(s) to be measured. | | | |

Example Table 5 shows an example option (Option C) for BWP operation without restriction in NR. In this example, RLM, BM, and BFD measurements may be supported based at least in part on a non-cell-defining (NCD)-SSB within the active BWP.

Example Table 5

| | Prerequisite | | |
|---|---|---|---|
| | Feature | | Mandatory/ |
| Components | Groups | Note(s) | Optional |
| 1. UE performs | None | Note: This applies only | Optional with |
| RLM/BM/BFD and gapless | | to primary cell (PCell). | capability |
| L3 intra-frequency | | This may not be | signaling |
| measurements based at least | | applicable to RedCap or | |
| in part on NCD-SSB, where | | eRedCap UEs. | |
| the NCD-SSB is within the | | | |
| active DL BWP. | | | |
| 2. Bandwidth of UE- | | | |
| specific RRC configured | | | |
| BWP may not include | | | |
| bandwidth of the | | | |
| CORESET#0 (if | | | |
| CORESET#0 is present) | | | |
| and CD-SSB for | | | |
| PCell/PSCell (if configured) | | | |
| and bandwidth of the UE- | | | |
| specific RRC configured | | | |
| BWP may not include CD- | | | |
| SSB for SCell. | | | |
| 3. NCD-SSB within the | | | |
| active DL BWP can be used | | | |
| as the QCL source for other | | | |
| reference signal. | | | |
| 4. UE performs L3 intra- | | | |
| frequency measurements | | | |
| without gaps based on | | | |
| NCD-SSB, where the NCD- | | | |
| SSB is within the active DL | | | |
| BWP. | | | |

Example Table 6 shows an example option (Option A) for BWP operation without restriction in NR. In this example, RLM, BM, and BFD measurements may be supported based at least in part on a CSI-RS when the CD-SSB is outside of the active BWP.

Example Table 6

| | Prerequisite | | |
|---|---|---|---|
| | Feature | | Mandatory/ |
| Components | Groups | Note(s) | Optional |
| 1. UE performs | 1-7, 2-24, | Note: The CD-SSB is | Optional with |
| RLM/BM/BFD | 2-31 | within the bandwidth of | capability |
| measurements based at least | | the carrier configured by | signaling |
| in part on CSI-RS, when | | SCS-SpecificCarrier of | |
| CD-SSB is outside active | | downlinkChannelBW- | |
| DL BWP. | | PerSCS-List in | |
| 2. Bandwidth of UE- | | ServingCellConfig. | |
| specific RRC configured | | This may not be | |
| BWP may not include | | applicable to RedCap or | |
| bandwidth of the | | eRedCap UEs. | |
| CORESET#0 (if | | | |
| CORESET#0 is present) | | | |
| and CD-SSB for | | | |
| PCell/PSCell (if configured) | | | |
| and bandwidth of the UE- | | | |
| specific RRC configured | | | |
| BWP may not include CD- | | | |
| SSB for SCell. | | | |

In some examples, an RRC configuration of an NCD-SSB may have the following characteristics. A BWP-DownlinkDedicated may include nonCellDefiningSSB and servingCellMO. A nonCellDefiningSSB may include absoluteFrequencySSB, ssb-Periodicity, and ssb-TimeOffset. If configured, the UE operating in this BWP may use the SSB for the purposes for which it would otherwise have used the CD-SSB of the serving cell (for example obtaining sync, measurements, and RLM, among other examples). Other parts of the BWP configuration that refer to an SSB (for example the “SSB” configured in the QCL-Info IE, the “ssb-Index” configured in the RadioLinkMonitoringRS, CFRA-SSB-Resource (where CFRA refers to contention-free random access), and PRACH-ResourceDedicatedBFR (where BFR refers to beam failure recovery)) may refer (implicitly) to this NCD-SSB. The NCD-SSB may have the same values for the properties (for example, ssb-PositionsInBurst, PCI, and ssb-PBCH-BlockPower) of the corresponding CD-SSB apart from the values of the properties configured in the NonCellDefiningSSB-r17 information element. In some examples, if the ‘servingCellMO’ field is present in a downlink BWP and the BWP is activated, the UE may use this measurement object for serving cell measurements (for example, including those used in measurement report triggering events). Otherwise, the UE may use the servingCellMO in the ServingCellConfig information element. In some examples, the NCD-SSB may be used as QCL source for the RLM, BFD, random access channel (RACH) occasion (RO) selection, and in transmission configuration indicator (TCI) states. For neighbor cell measurements, it may be up to network whether to configure a measurement object (MO) on the CD-SSB, the NCD-SSB, or both the CD-SSB and the NCD-SSB. The network may configure a dedicated BWP associated with NCD-SSB in a reconfiguration WithSync. However, NCD-SSB may not be indicated in a handover command. For example, the network sets ServingCellConfigCommon=>downlinkConfigCommon=>frequencyInfoDL=>absolute FrequencySSB to the frequency of the CD-SSB (not the NCD-SSB) even if the first active BWP in the target cell is associated with NCD-SSB.

As described herein, MG activation or deactivation may be performed in accordance with one or more UE autonomous rules. For a RedCap UE, SSB intra-frequency measurements may be performed without an MG if the SSB is completely contained in the active BWP or the active DL BWP is an initial BWP. For a non-RedCap UE supporting nr-NeedForGapNCSG-reporting-r17 and indicating a NeedForGapNCSG-InfoNR for intra-frequency measurements, an SSB intra-frequency measurement may be performed without an MG if the UE indicates ‘nogap-noncsg’ via a NeedForGapNCSG-InfoNR indicator, the SSB is not completely contained in the active BWP, and the active downlink BWP is not an initial BWP. Additionally, for the non-RedCap UE and for a legacy MG or a NCSG, an SSB intra-frequency measurement may be performed without the MG if the CD-SSB is within the configured UE-specific CBW, the UE indicates ‘no-gap’ via an intraFreq-needForGap indicator, the SSB is completely contained in the active BWP, or the active downlink BWP is an initial BWP. However, the UE autonomous rules may not include rules for NCD-SSB measurements. For example, the UE autonomous MG activation and deactivation rules for configured (pre-configured) MG may not indicate that the UE is to perform L3 intra-frequency measurements without gaps based at least in part on the NCD-SSB, where the NCD-SSB is within the active DL BWP. This may result in the UE failing to perform MG activation or deactivation based at least in part on NCD-SSB measurements. Therefore, the UE may perform unnecessary MG measurements in accordance with not deactivating an MG based at least in part on the NCD-SSB measurements, or may fail to perform an MG measurement in accordance with not activating an MG based at least in part on the NCD-SSB measurements.

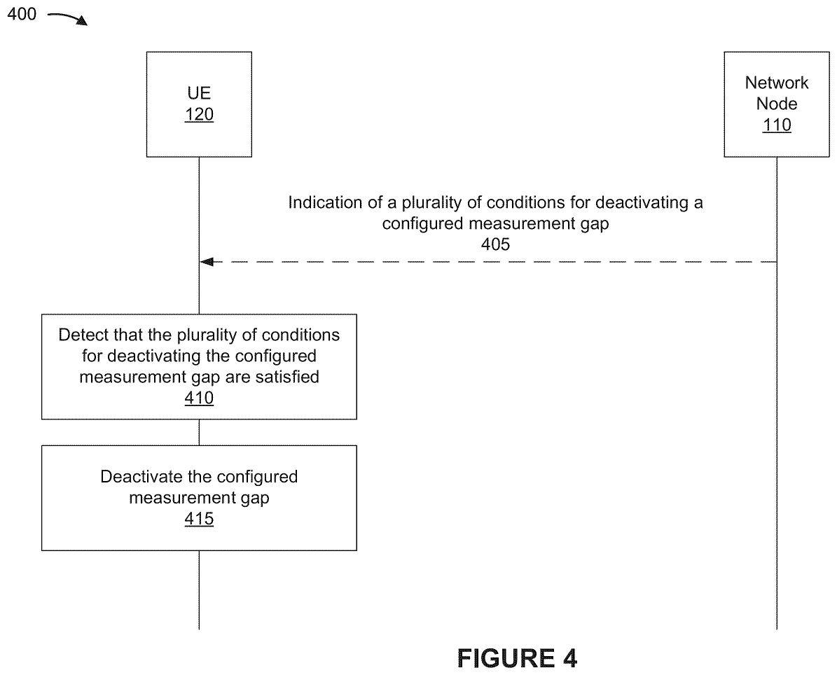

FIG. 4 is a diagram illustrating an example 400 of measurement gap deactivation. As shown in a first operation associated with reference number 405, the network node 110 may transmit, and the UE 120 may receive, an indication of a plurality of conditions for deactivating a configured (for example, pre-configured) measurement gap. The plurality of conditions for deactivating the configured measurement gap may be based at least in part on a configuration of an NCD-SSB and a serving cell measurement object (servingCellMO) of an active downlink BWP of the UE 120. In some aspects, the UE 120 may be a legacy UE (for example, a non-RedCap UE) that supports Option C (described herein) for BWP operation without restriction in NR. Therefore, RLM, BM, and BFD measurements may be supported by the UE 120 based at least in part on the NCD-SSB within the active BWP of the UE 120.

In some aspects, the one or more conditions include that the configured measurement gap is to be deactivated if (for example, only if) the configured measurements for the configured measurement gap are SSB or CSI-RS intra-frequency measurements and the measurements can be performed without the measurement gap. In some aspects, configured measurements for a measurement gap (such as a legacy measurement gap or NCSG) may be able to be performed without the measurement gap if the target SSB is completely contained in the active downlink BWP of the UE (for example, provided the UE supports Option C described herein) and a serving cell measurement object (for example, servingCellMO) is present in a corresponding BWP downlink dedicated information element (BWP-DownlinkDedicated). Additionally or alternatively, the measurements associated with the measurement gap (such as the legacy measurement gap or NCSG) may be able to be performed without the measurement gap if a CD-SSB is within a configured UE-specific CBW (provided the UE supports Option B described herein), the UE indicates ‘no-gap’ via intraFreq-needForGap, the SSB is completely contained in the active BWP of the UE, or the active downlink BWP of the UE is an initial BWP.

As shown in a second operation associated with reference number 410, the UE 120 may detect that the plurality of conditions for deactivating the configured measurement gap are satisfied. For example, the UE 120 may detect that the measurements for the configured measurement gap (such as the legacy measurement gap or NCSG) are SSB or CSI-RS intra-frequency measurements and may detect that the measurements can be performed without the measurement gap. The UE 120 may detect that the measurements can be performed without the measurement gap based at least in part on the target SSB being completely contained in the active downlink BWP of the UE 120 (for example, provided the UE supports Option C described herein) and based at least in part on a serving cell measurement object (for example, servingCellMO) being present in a corresponding BWP downlink dedicated information element (BWP-DownlinkDedicated).

As shown in a third operation associated with reference number 415, the UE 120 may deactivate the configured measurement gap. The UE 120 may deactivate the configured measurement gap in accordance with detecting that the plurality of conditions for deactivating the configured measurement gap have been satisfied. As described herein, deactivating the configured measurement gap may enable the UE 120 to perform measurements, such as Layer 3 intra-frequency NCD-SSB measurements, outside of the configured measurement gap.

In some aspects, the UE 120 may detect that the plurality of conditions for deactivating the configured measurement gap are not satisfied. The UE 120 may activate the configured measurement gap in accordance with detecting that the plurality of conditions for deactivating the configured measurement gap are not satisfied. Additionally or alternatively, the UE 120 may not detect (e.g., may fail to detect) that the plurality of conditions for deactivating the configured measurement gap are satisfied. The UE 120 may activate the configured measurement gap in accordance with not detecting that the plurality of conditions for deactivating the configured measurement gap are satisfied. In some aspects a configured measurement gap may be activated or deactivated at each BWP switching occurrence of a plurality of BWP switching occurrences. For example, a configured measurement gap may be activated at a first BWP switching occurrence, deactivated at a second BWP switching occurrence that occurs after the first BWP switching occurrence, and activated (e.g., re-activated) at a third BWP switching occurrence that occurs after the second BWP switching occurrence.

FIG. 5 is a flowchart illustrating an example process 500 performed, for example, at a UE or an apparatus of a UE that supports wireless communication. Example process 500 is an example where the apparatus or the UE (for example, UE 120) performs operations associated with measurement gap deactivation.

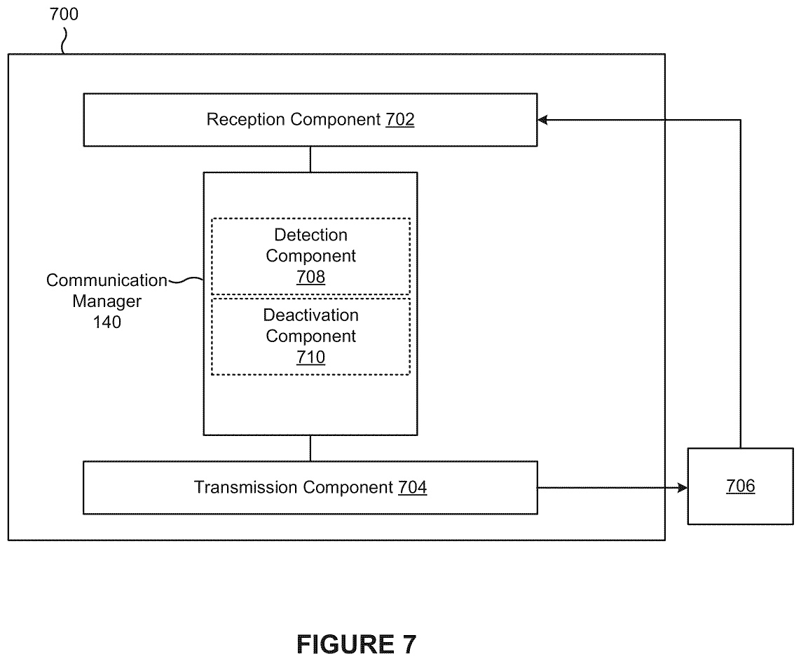

As shown in FIG. 5, in some aspects, process 500 may include detecting that a plurality of conditions for deactivating a configured measurement gap are satisfied, wherein the plurality of conditions include that: configured measurements within the configured measurement gap are SSB intra-frequency measurements or CSI-RS intra-frequency measurements, the configured measurements are able to be performed without the configured measurement gap, a target measurement SSB is completely contained in an active downlink BWP of the UE, and a serving cell measurement object indicator is included in a corresponding BWP downlink dedicated information element (block 510). For example, the UE (such as by using communication manager 140 or detection component 708, depicted in FIG. 7) may detect that a plurality of conditions for deactivating a configured measurement gap are satisfied, wherein the plurality of conditions include that: configured measurements within the configured measurement gap are SSB intra-frequency measurements or CSI-RS intra-frequency measurements, the configured measurements are able to be performed without the configured measurement gap, a target measurement SSB is completely contained in an active downlink BWP of the UE, and a serving cell measurement object indicator is included in a corresponding BWP downlink dedicated information element, as described above.

As further shown in FIG. 5, in some aspects, process 500 may include deactivating the configured measurement gap in accordance with the plurality of conditions being satisfied (block 520). For example, the UE (such as by using communication manager 140 or deactivation component 710, depicted in FIG. 7) may deactivate the configured measurement gap in accordance with the plurality of conditions being satisfied, as described above.

Process 500 may include additional aspects, such as any single aspect or any combination of aspects described below or in connection with one or more other processes described elsewhere herein.

In a first additional aspect, the target measurement SSB is a non-cell-defining SSB that is included within the active downlink BWP of the UE.

In a second additional aspect, alone or in combination with the first aspect, the plurality of conditions are based at least in part on a configuration of the non-cell-defining SSB and the serving cell measurement object indicator.

In a third additional aspect, alone or in combination with one or more of the first and second aspects, process 500 includes detecting that one or more other conditions of a plurality of conditions for performing SSB intra-frequency measurements without the configured measurement gap are satisfied.

In a fourth additional aspect, alone or in combination with one or more of the first through third aspects, the conditions for performing SSB intra-frequency measurements without the configured measurement gap include that a cell-defining SSB is within a configured UE-specific channel bandwidth, the UE transmits a no-gap indicator, the SSB is completely contained in the active downlink BWP, and the active downlink BWP is an initial BWP.

In a fifth additional aspect, alone or in combination with one or more of the first through fourth aspects, the no-gap indicator is included within an intraFreq-needForGap information element.

In a sixth additional aspect, alone or in combination with one or more of the first through fifth aspects, the serving cell measurement object indicator is a servingCellMO indicator and the BWP downlink dedicated information element is a BWP-Downlink Dedicated information element.

Although FIG. 5 shows example blocks of process 500, in some aspects, process 500 may include additional blocks, fewer blocks, different blocks, or differently arranged blocks than those depicted in FIG. 5. Additionally or alternatively, two or more of the blocks of process 500 may be performed in parallel.

FIG. 6 is a flowchart illustrating an example process 600 performed, for example, at a network node or an apparatus of a network node that supports wireless communication. Example process 600 is an example where the apparatus or the network node (for example, network node 110) performs operations associated with measurement gap deactivation.

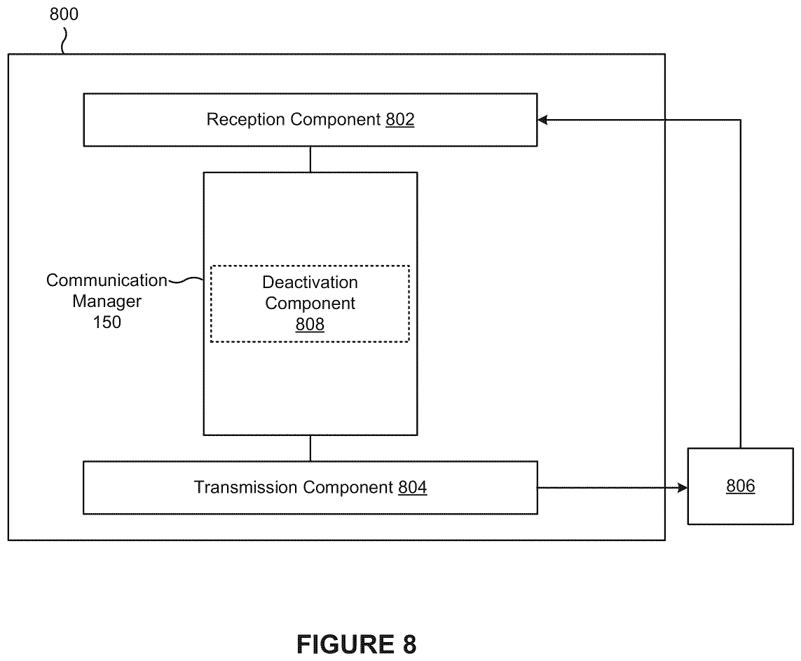

As shown in FIG. 6, in some aspects, process 600 may include transmitting an indication of a plurality of conditions for deactivating a configured measurement gap (block 610). For example, the network node (such as by using communication manager 150 or transmission component 804, depicted in FIG. 8) may transmit an indication of a plurality of conditions for deactivating a configured measurement gap, as described above.

As further shown in FIG. 6, in some aspects, process 600 may include deactivating the configured measurement gap in accordance with the plurality of conditions being satisfied, wherein the plurality of conditions include that: configured measurements within the configured measurement gap are SSB intra-frequency measurements or CSI-RS intra-frequency measurements, the configured measurements are able to be performed without the configured measurement gap, a target measurement SSB is completely contained in an active downlink BWP of a UE, and a serving cell measurement object indicator is included in a corresponding BWP downlink dedicated information element (block 620). For example, the network node (such as by using communication manager 150 or deactivation component 808, depicted in FIG. 8) may deactivate the configured measurement gap in accordance with the plurality of conditions being satisfied, wherein the plurality of conditions include that: configured measurements within the configured measurement gap are SSB intra-frequency measurements or CSI-RS intra-frequency measurements, the configured measurements are able to be performed without the configured measurement gap, a target measurement SSB is completely contained in an active downlink BWP of a UE, and a serving cell measurement object indicator is included in a corresponding BWP downlink dedicated information element, as described above.

Process 600 may include additional aspects, such as any single aspect or any combination of aspects described below or in connection with one or more other processes described elsewhere herein.

In a first additional aspect, the target measurement SSB is a non-cell-defining SSB that is included within the active downlink BWP of the UE.

In a second additional aspect, alone or in combination with the first aspect, the plurality of conditions are based at least in part on a configuration of the non-cell-defining SSB and the serving cell measurement object indicator.

In a third additional aspect, alone or in combination with one or more of the first and second aspects, process 600 includes detecting that one or more other conditions of a plurality of conditions for performing SSB intra-frequency measurements without the configured measurement gap are satisfied.

In a fourth additional aspect, alone or in combination with one or more of the first through third aspects, the conditions for performing SSB intra-frequency measurements without the configured measurement gap include that a cell-defining SSB is within a configured UE-specific channel bandwidth, the UE transmits a no-gap indicator, the SSB is completely contained in the active downlink BWP, and the active downlink BWP is an initial BWP.

In a fifth additional aspect, alone or in combination with one or more of the first through fourth aspects, the no-gap indicator is included within an intraFreq-needForGap information element.

In a sixth additional aspect, alone or in combination with one or more of the first through fifth aspects, the serving cell measurement object indicator is a servingCellMO indicator and the BWP downlink dedicated information element is a BWP-Downlink Dedicated information element.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a diagram of an example apparatus 700 for wireless communication that supports measurement gap deactivation. The apparatus 700 may be a UE, or a UE may include the apparatus 700. In some aspects, the apparatus 700 includes a reception component 702, a transmission component 704, and a communication manager 140, which may be in communication with one another (for example, via one or more buses). As shown, the apparatus 700 may communicate with another apparatus 706 (such as a UE, a network node, or another wireless communication device) using the reception component 702 and the transmission component 704.

In some aspects, the apparatus 700 may be configured to and/or operable to perform one or more operations described herein in connection with FIG. 4. Additionally or alternatively, the apparatus 700 may be configured to and/or operable to perform one or more processes described herein, such as process 500 of FIG. 5. In some aspects, the apparatus 700 may include one or more components of the UE described above in connection with FIG. 2.

The reception component 702 may receive communications, such as reference signals, control information, and/or data communications, from the apparatus 706. The reception component 702 may provide received communications to one or more other components of the apparatus 700, such as the communication manager 140. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 702 may include one or more antennas, one or more modems, one or more demodulators, one or more MIMO detectors, one or more receive processors, one or more controllers/processors, and/or one or more memories of the UE described above in connection with FIG. 2.

The transmission component 704 may transmit communications, such as reference signals, control information, and/or data communications, to the apparatus 706. In some aspects, the communication manager 140 may generate communications and may transmit the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, one or more modems, one or more modulators, one or more transmit MIMO processors, one or more transmit processors, one or more controllers/processors, and/or one or more memories of the UE described above in connection with FIG. 2. In some aspects, the transmission component 704 may be co-located with the reception component 702 in one or more transceivers.

The communication manager 140 may detect that a plurality of conditions for deactivating a configured measurement gap are satisfied, wherein the plurality of conditions include that configured measurements within the configured measurement gap are SSB intra-frequency measurements or CSI-RS intra-frequency measurements, the configured measurements are able to be performed without the configured measurement gap, a target measurement SSB is completely contained in an active downlink BWP of the UE, and a serving cell measurement object indicator is included in a corresponding BWP downlink dedicated information element. The communication manager 140 may deactivate the configured measurement gap in accordance with the plurality of conditions being satisfied. In some aspects, the communication manager 140 may perform one or more operations described elsewhere herein as being performed by one or more components of the communication manager 140.

The communication manager 140 may include one or more controllers/processors and/or one or more memories of the UE described above in connection with FIG. 2. In some aspects, the communication manager 140 includes a set of components, such as a detection component 708, and/or a deactivation component 710. Alternatively, the set of components may be separate and distinct from the communication manager 140. In some aspects, one or more components of the set of components may include or may be implemented within one or more controllers/processors and/or one or more memories of the UE described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The detection component 708 may detect that a plurality of conditions for deactivating a configured measurement gap are satisfied, wherein the plurality of conditions include that configured measurements within the configured measurement gap are SSB intra-frequency measurements or CSI-RS intra-frequency measurements, the configured measurements are able to be performed without the configured measurement gap, a target measurement SSB is completely contained in an active downlink BWP of the UE, and a serving cell measurement object indicator is included in a corresponding BWP downlink dedicated information element. The deactivation component 710 may deactivate the configured measurement gap in accordance with the plurality of conditions being satisfied. The detection component 708 may detect that one or more other conditions of a plurality of conditions for performing SSB intra-frequency measurements without the configured measurement gap are satisfied.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

FIG. 8 is a diagram of an example apparatus 800 for wireless communication that supports measurement gap deactivation. The apparatus 800 may be a network node, or a network node may include the apparatus 800. In some aspects, the apparatus 800 includes a reception component 802, a transmission component 804, and a communication manager 150, which may be in communication with one another (for example, via one or more buses). As shown, the apparatus 800 may communicate with another apparatus 806 (such as a UE, a network node, or another wireless communication device) using the reception component 802 and the transmission component 804.

In some aspects, the apparatus 800 may be configured to and/or operable to perform one or more operations described herein in connection with FIG. 4. Additionally or alternatively, the apparatus 800 may be configured to and/or operable to perform one or more processes described herein, such as process 600 of FIG. 6. In some aspects, the apparatus 800 may include one or more components of the network node described above in connection with FIG. 2.

The reception component 802 may receive communications, such as reference signals, control information, and/or data communications, from the apparatus 806. The reception component 802 may provide received communications to one or more other components of the apparatus 800, such as the communication manager 150. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 802 may include one or more antennas, one or more modems, one or more demodulators, one or more MIMO detectors, one or more receive processors, one or more controllers/processors, and/or one or more memories of the network node described above in connection with FIG. 2.

The transmission component 804 may transmit communications, such as reference signals, control information, and/or data communications, to the apparatus 806. In some aspects, the communication manager 150 may generate communications and may transmit the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, one or more modems, one or more modulators, one or more transmit MIMO processors, one or more transmit processors, one or more controllers/processors, and/or one or more memories of the network node described above in connection with FIG. 2. In some aspects, the transmission component 804 may be co-located with the reception component 802 in one or more transceivers.

The communication manager 150 may transmit or may cause the transmission component 804 to transmit an indication of a plurality of conditions for deactivating a configured measurement gap. The communication manager 150 may deactivate the configured measurement gap in accordance with the plurality of conditions being satisfied, wherein the plurality of conditions include that configured measurements within the configured measurement gap are SSB intra-frequency measurements or CSI-RS intra-frequency measurements, the configured measurements are able to be performed without the configured measurement gap, a target measurement SSB is completely contained in an active downlink BWP of a UE, and a serving cell measurement object indicator is included in a corresponding BWP downlink dedicated information element. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 2. In some aspects, the communication manager 150 includes a set of components, such as a deactivation component 808. Alternatively, the set of components may be separate and distinct from the communication manager 150. In some aspects, one or more components of the set of components may include or may be implemented within one or more controllers/processors, one or more memories, one or more schedulers, and/or one or more communication units of the network node described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The transmission component 804 may transmit an indication of a plurality of conditions for deactivating a configured measurement gap. The deactivation component 808 may deactivate the configured measurement gap in accordance with the plurality of conditions being satisfied, wherein the plurality of conditions include that configured measurements within the configured measurement gap are SSB intra-frequency measurements or CSI-RS intra-frequency measurements, the configured measurements are able to be performed without the configured measurement gap, a target measurement SSB is completely contained in an active downlink BWP of a UE, and a serving cell measurement object indicator is included in a corresponding BWP downlink dedicated information element.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed at a user equipment (UE), comprising: detecting that a plurality of conditions for deactivating a configured measurement gap are satisfied, wherein the plurality of conditions include that: configured measurements within the configured measurement gap are synchronization signal block (SSB) intra-frequency measurements or channel state information reference signal (CSI-RS) intra-frequency measurements, the configured measurements are able to be performed without the configured measurement gap, a target measurement SSB is completely contained in an active downlink bandwidth-part (BWP) of the UE, and a serving cell measurement object indicator is included in a corresponding BWP downlink dedicated information element; and deactivating the configured measurement gap in accordance with the plurality of conditions being satisfied.

Aspect 2: The method of Aspect 1, wherein the target measurement SSB is a non-cell-defining SSB that is included within the active downlink BWP of the UE.

Aspect 3: The method of Aspect 2, wherein the plurality of conditions are based at least in part on a configuration of the non-cell-defining SSB and the serving cell measurement object indicator.

Aspect 4: The method of any of Aspects 1-3, further comprising detecting that one or more other conditions of a plurality of conditions for performing SSB intra-frequency measurements without the configured measurement gap are satisfied.

Aspect 5: The method of Aspect 4, wherein the conditions for performing SSB intra-frequency measurements without the configured measurement gap include that a cell-defining SSB is within a configured UE-specific channel bandwidth, the UE transmits a no-gap indicator, the SSB is completely contained in the active downlink BWP, and the active downlink BWP is an initial BWP.

Aspect 6: The method of Aspect 5, wherein the no-gap indicator is included within an intraFreq-needForGap information element.

Aspect 7: The method of any of Aspects 1-6, wherein the serving cell measurement object indicator is a servingCellMO indicator and the BWP downlink dedicated information element is a BWP-DownlinkDedicated information element.

Aspect 8: A method of wireless communication performed at a network node, comprising: transmitting an indication of a plurality of conditions for deactivating a configured measurement gap; and deactivating the configured measurement gap in accordance with the plurality of conditions being satisfied, wherein the plurality of conditions include that: configured measurements within the configured measurement gap are synchronization signal block (SSB) intra-frequency measurements or channel state information reference signal (CSI-RS) intra-frequency measurements, the configured measurements are able to be performed without the configured measurement gap, a target measurement SSB is completely contained in an active downlink bandwidth-part (BWP) of a user equipment (UE), and a serving cell measurement object indicator is included in a corresponding BWP downlink dedicated information element.

Aspect 9: The method of Aspect 8, wherein the target measurement SSB is a non-cell-defining SSB that is included within the active downlink BWP of the UE.

Aspect 10: The method of Aspect 9, wherein the plurality of conditions are based at least in part on a configuration of the non-cell-defining SSB and the serving cell measurement object indicator.

Aspect 11: The method of any of Aspects 8-10, further comprising detecting that one or more other conditions of a plurality of conditions for performing SSB intra-frequency measurements without the configured measurement gap are satisfied.

Aspect 12: The method of Aspect 11, wherein the conditions for performing SSB intra-frequency measurements without the configured measurement gap include that a cell-defining SSB is within a configured UE-specific channel bandwidth, the UE transmits a no-gap indicator, the SSB is completely contained in the active downlink BWP, and the active downlink BWP is an initial BWP.

Aspect 13: The method of Aspect 12, wherein the no-gap indicator is included within an intraFreq-needForGap information element.

Aspect 14: The method of any of Aspects 8-13, wherein the serving cell measurement object indicator is a servingCellMO indicator and the BWP downlink dedicated information element is a BWP-DownlinkDedicated information element.

Aspect 15: An apparatus for wireless communication at a user equipment (UE), comprising: one or more memories storing processor-executable code; and one or more processors coupled with the one or more memories, at least one processor of the one or more processors configured to cause the UE to: detect that a plurality of conditions for deactivating a configured measurement gap are satisfied, wherein the plurality of conditions include that: configured measurements within the configured measurement gap are synchronization signal block (SSB) intra-frequency measurements or channel state information reference signal (CSI-RS) intra-frequency measurements, the configured measurements are able to be performed without the configured measurement gap, a target measurement SSB is completely contained in an active downlink bandwidth-part (BWP) of the UE, and a serving cell measurement object indicator is included in a corresponding BWP downlink dedicated information element; and deactivate the configured measurement gap in accordance with the plurality of conditions being satisfied.

Aspect 16: The apparatus of Aspect 15, wherein the target measurement SSB is a non-cell-defining SSB that is included within the active downlink BWP of the UE.

Aspect 17: The apparatus of Aspect 16, wherein the plurality of conditions are based at least in part on a configuration of the non-cell-defining SSB and the serving cell measurement object indicator.

Aspect 18: The apparatus of any of Aspects 15-17, wherein at least one processor of the one or more processors is configured to cause the UE to detect that one or more other conditions of a plurality of conditions for performing SSB intra-frequency measurements without the configured measurement gap are satisfied.

Aspect 19: The apparatus of Aspect 18, wherein the conditions for performing SSB intra-frequency measurements without the configured measurement gap include that a cell-defining SSB is within a configured UE-specific channel bandwidth, the UE transmits a no-gap indicator, the SSB is completely contained in the active downlink BWP, and the active downlink BWP is an initial BWP.

Aspect 20: The apparatus of Aspect 19, wherein the no-gap indicator is included within an intraFreq-needForGap information element.

Aspect 21: The apparatus of any of Aspects 15-20, wherein the serving cell measurement object indicator is a servingCellMO indicator and the BWP downlink dedicated information element is a BWP-DownlinkDedicated information element.

Aspect 22: An apparatus for wireless communication at a network node, comprising: one or more memories storing processor-executable code; and one or more processors coupled with the one or more memories, at least one processor of the one or more processors configured to cause the network node to: transmit an indication of a plurality of conditions for deactivating a configured measurement gap; and deactivate the configured measurement gap in accordance with the plurality of conditions being satisfied, wherein the plurality of conditions include that: configured measurements within the configured measurement gap are synchronization signal block (SSB) intra-frequency measurements or channel state information reference signal (CSI-RS) intra-frequency measurements, the configured measurements are able to be performed without the configured measurement gap, a target measurement SSB is completely contained in an active downlink bandwidth-part (BWP) of a user equipment (UE), and a serving cell measurement object indicator is included in a corresponding BWP downlink dedicated information element.

Aspect 23: The apparatus of Aspect 22, wherein the target measurement SSB is a non-cell-defining SSB that is included within the active downlink BWP of the UE.

Aspect 24: The apparatus of Aspect 23, wherein the plurality of conditions are based at least in part on a configuration of the non-cell-defining SSB and the serving cell measurement object indicator.

Aspect 25: The apparatus of any of Aspects 22-24, wherein at least one processor of the one or more processors is configured to cause the network node to detect that one or more other conditions of a plurality of conditions for performing SSB intra-frequency measurements without the configured measurement gap are satisfied.

Aspect 26: The apparatus of Aspect 25, wherein the conditions for performing SSB intra-frequency measurements without the configured measurement gap include that a cell-defining SSB is within a configured UE-specific channel bandwidth, the UE transmits a no-gap indicator, the SSB is completely contained in the active downlink BWP, and the active downlink BWP is an initial BWP.

Aspect 27: The apparatus of Aspect 26, wherein the no-gap indicator is included within an intraFreq-needForGap information element.

Aspect 28: The apparatus of any of Aspects 22-27, wherein the serving cell measurement object indicator is a servingCellMO indicator and the BWP downlink dedicated information element is a BWP-DownlinkDedicated information element.

Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-14.

Aspect 30: An apparatus for wireless communication at a device, the apparatus comprising one or more memories and one or more processors coupled to the one or more memories, the one or more processors configured to cause the device to perform the method of one or more of Aspects 1-14.

Aspect 31: An apparatus for wireless communication, the apparatus comprising at least one means for performing the method of one or more of Aspects 1-14.

Aspect 32: A non-transitory computer-readable medium storing code for wireless communication, the code comprising instructions executable by one or more processors to perform the method of one or more of Aspects 1-14.

Aspect 33: A non-transitory computer-readable medium storing a set of instructions for wireless communication, the set of instructions comprising one or more instructions that, when executed by one or more processors of a device, cause the device to perform the method of one or more of Aspects 1-14.

Aspect 34: A device for wireless communication, the device comprising a processing system that includes one or more processors and one or more memories coupled with the one or more processors, the processing system configured to cause the device to perform the method of one or more of Aspects 1-14.

Aspect 35: An apparatus for wireless communication at a device, the apparatus comprising one or more memories and one or more processors coupled to the one or more memories, the one or more processors individually or collectively configured to cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), identifying, inferring, ascertaining, measuring, and the like. Also, “determining” can include receiving (such as receiving information or receiving an indication), accessing (such as accessing data stored in memory), transmitting (such as transmitting information) and the like. Also, “determining” can include resolving, selecting, obtaining, choosing, establishing and other such similar actions. The term “identify” or “identifying” also encompasses a wide variety of actions and, therefore, “identifying” can include calculating, computing, processing, deriving, investigating, looking up (such as via looking up in a table, a database or another data structure), inferring, ascertaining, measuring, and the like. Also, “identifying” can include receiving (such as receiving information or receiving an indication), accessing (such as accessing data stored in memory), transmitting (such as transmitting information) and the like. Also, “identifying” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
detect that a plurality of conditions for deactivating a configured measurement gap are satisfied, wherein the plurality of conditions include that:
configured measurements within the configured measurement gap are synchronization signal block (SSB) intra-frequency measurements or channel state information reference signal (CSI-RS) intra-frequency measurements,
the configured measurements are able to be performed without the configured measurement gap,
a target measurement SSB is completely contained in an active downlink bandwidth-part (BWP) of the UE, and
a serving cell measurement object indicator is included in a corresponding BWP downlink dedicated information element; and
deactivate the configured measurement gap in accordance with the plurality of conditions being satisfied.

2. The apparatus of claim 1, wherein the target measurement SSB is a non-cell-defining SSB that is included within the active downlink BWP of the UE.

3. The apparatus of claim 2, wherein the plurality of conditions are based at least in part on a configuration of the non-cell-defining SSB and the serving cell measurement object indicator.

4. The apparatus of claim 1, wherein at least one processor of the one or more processors is configured to cause the UE to detect that one or more other conditions of a plurality of conditions for performing SSB intra-frequency measurements without the configured measurement gap are satisfied.

5. The apparatus of claim 4, wherein the conditions for performing SSB intra-frequency measurements without the configured measurement gap include that a cell-defining SSB is within a configured UE-specific channel bandwidth, the UE transmits a no-gap indicator, the SSB is completely contained in the active downlink BWP, and the active downlink BWP is an initial BWP.

6. The apparatus of claim 5, wherein the no-gap indicator is included within an intraFreq-needForGap information element.

7. The apparatus of claim 1, wherein the serving cell measurement object indicator is a servingCellMO indicator and the BWP downlink dedicated information element is a BWP-DownlinkDedicated information element.

8. A method of wireless communication performed at a user equipment (UE), comprising:
detecting that a plurality of conditions for deactivating a configured measurement gap are satisfied, wherein the plurality of conditions include that:
configured measurements within the configured measurement gap are synchronization signal block (SSB) intra-frequency measurements or channel state information reference signal (CSI-RS) intra-frequency measurements,
the configured measurements are able to be performed without the configured measurement gap,
a target measurement SSB is completely contained in an active downlink bandwidth-part (BWP) of the UE, and
a serving cell measurement object indicator is included in a corresponding BWP downlink dedicated information element; and
deactivating the configured measurement gap in accordance with the plurality of conditions being satisfied.

9. The method of claim 8, wherein the target measurement SSB is a non-cell-defining SSB that is included within the active downlink BWP of the UE.

10. The method of claim 9, wherein the plurality of conditions are based at least in part on a configuration of the non-cell-defining SSB and the serving cell measurement object indicator.

11. The method of claim 8, further comprising detecting that one or more other conditions of a plurality of conditions for performing SSB intra-frequency measurements without the configured measurement gap are satisfied.

12. The method of claim 11, wherein the conditions for performing SSB intra-frequency measurements without the configured measurement gap include that a cell-defining SSB is within a configured UE-specific channel bandwidth, the UE transmits a no-gap indicator, the SSB is completely contained in the active downlink BWP, and the active downlink BWP is an initial BWP.

13. The method of claim 12, wherein the no-gap indicator is included within an intraFreq-needForGap information element.

14. The method of claim 8, wherein the serving cell measurement object indicator is a servingCellMO indicator and the BWP downlink dedicated information element is a BWP-DownlinkDedicated information element.

15. An apparatus for wireless communication at a network node, comprising:
one or more memories storing processor-executable code; and
one or more processors coupled with the one or more memories, at least one processor of the one or more processors configured to cause the network node to:
transmit an indication of a plurality of conditions for deactivating a configured measurement gap; and
deactivate the configured measurement gap in accordance with the plurality of conditions being satisfied, wherein the plurality of conditions include that:
configured measurements within the configured measurement gap are synchronization signal block (SSB) intra-frequency measurements or channel state information reference signal (CSI-RS) intra-frequency measurements,
the configured measurements are able to be performed without the configured measurement gap,
a target measurement SSB is completely contained in an active downlink bandwidth-part (BWP) of a user equipment (UE), and
a serving cell measurement object indicator is included in a corresponding BWP downlink dedicated information element.

16. The apparatus of claim 15, wherein the target measurement SSB is a non-cell-defining SSB that is included within the active downlink BWP of the UE.

17. The apparatus of claim 16, wherein the plurality of conditions are based at least in part on a configuration of the non-cell-defining SSB and the serving cell measurement object indicator.

18. The apparatus of claim 15, wherein at least one processor of the one or more processors is configured to cause the network node to detect that one or more other conditions of a plurality of conditions for performing SSB intra-frequency measurements without the configured measurement gap are satisfied.

19. The apparatus of claim 18, wherein the conditions for performing SSB intra-frequency measurements without the configured measurement gap include that a cell-defining SSB is within a configured UE-specific channel bandwidth, the UE transmits a no-gap indicator, the SSB is completely contained in the active downlink BWP, and the active downlink BWP is an initial BWP.

20. The apparatus of claim 15, wherein the serving cell measurement object indicator is a servingCellMO indicator and the BWP downlink dedicated information element is a BWP-DownlinkDedicated information element.
